(19) United States
(12) Patent Application Publication
(10) Pub. No.: US 2026/0119191 A1
(43) Pub. Date: Apr. 30, 2026

(54) Method of Starting a Server, Apparatus and System, Non-Volatile Readable Storage Medium, and Electronic Device

(71) Applicant: SUZHOU METABRAIN INTELLIGENT TECHNOLOGY CO., LTD., Suzhou, Jiangsu (CN)

(72) Inventors: Yongbo SUN, Suzhou, Jiangsu (CN); Daotong LI, Suzhou, Jiangsu (CN); Binghui ZHANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/469,459

(22) PCT Filed: Aug. 30, 2024
(86) PCT No.: PCT/CN2024/116072

§ 371 Date: Sep. 26, 2025

(30) Foreign Application Priority Data
Jan. 31, 2024 (CN) 202410134600.0

(51) Int. Cl. G06F 9/4401

(52) U.S. Cl. CPC G06F 9/4406; G06F 9/4403

(57) ABSTRACT

Provided are a method of starting a server, apparatus and system, a non-volatile readable storage medium, and an electronic device. The method includes: in a case where the server is started and before the server runs the boot loader, detecting a reference storage segment in the storage space, wherein the reference storage segment is a storage segment, a storage capacity of which is smaller than a file size of the system file, in the storage space; and editing the reference storage segment as a target storage segment that is not allowed to be allocated to the boot loader for storing the system file.

### CROSS-REFERENCE TO RELATED APPLICATION

This present disclosure is a National Stage Filing of the PCT International Application No. PCT/CN2024/116072 filed on Aug. 30, 2024, which claims priority to Chinese Patent Application No. 202410134600.0, filed to the China National Intellectual Property Administration on Jan. 31, 2024 and entitled “Method of Starting a Server, Apparatus and System, Storage Medium, and Electronic Device” the entire contents of each of which are hereby incorporated by reference for all purposes.

### TECHNICAL FIELD

Embodiments of the present disclosure relate to the field of computers, and in particular, a method of starting a server, apparatus and system, a non-volatile readable storage medium, and an electronic device.

### BACKGROUND

At present, a boot loader is generally used to load a corresponding operating system for a server. In the related art, the boot loader stores a system file in a storage space of the server and loads the operating system for the server through the system file. However, in actual operation, in a case where the size of the system file to be stored is larger than the storage capacity of the storage space applied by the boot loader, an “overlap” conflict in file storage in the storage space may occur, which causes the boot loader to crash and fail to start the server normally, thereby reducing the server startup efficiency.

For the problems in the related art, such as low server startup efficiency, no effective technical solution has been proposed.

### SUMMARY

Embodiments of the present disclosure provide a method of starting a server, apparatus and system, a non-volatile readable storage medium, and an electronic device, so as to at least solve the problem in the related art of low server startup efficiency.

According to a first aspect, a method of starting a server is provided. An initialization module, a boot loader, and a storage space are deployed on a server. The initialization module is configured to initialize server hardware of the server in a case where the server is started, and the boot loader is configured to store a system file in the storage space and use the system file to load an operating system for the server. The method is applied to the initialization module, and includes the following operations.

In a case where the server is started and before the server runs the boot loader, a reference storage segment in the storage space is detected, where the reference storage segment is a storage segment, a storage capacity of which is smaller than a file size of a system file, in the storage space.

The reference storage segment is edited as a target storage segment that is not allowed to be allocated to the boot loader for storing the system file, where after the reference storage segment is edited as the target storage segment, the boot loader is allowed to be run.

In one exemplary embodiment, the operation of the editing the reference storage segment as a target storage segment that is not allowed to be allocated to the boot loader for storing the system file includes: querying a second spatial attribute of the reference storage segment, where the second spatial attribute is configured to indicate usage of the reference storage segment; and configuring the second spatial attribute as unavailable to obtain the target storage segment, where a storage segment, the spatial attribute of which is configured as unavailable, is not allowed to be allocated to the boot loader for storing the system file.

In one exemplary embodiment, the operation of the editing the reference storage segment as a target storage segment that is not allowed to be allocated to the boot loader for storing the system file includes: querying a space type of the reference storage segment, where the space type is configured to indicate a service type of a storage service provided by a storage segment; and configuring the space type as a target type to obtain the target storage segment, where the boot loader is only allowed to use a storage segment, the space type of which is a reference type.

In one exemplary embodiment, the operation of the configuring the space type as a target type to obtain the target storage segment includes: configuring the space type as a runtime service type to obtain the target storage segment, wherein the target type is the runtime service type, a storage segment, a space type of which is configured as the runtime service type, is not configured to provide a storage service for a stage of loading the operating system, the reference type includes a boot service type, and a storage segment, a space type of which is configured as the boot service type, is configured to provide the storage service for the stage of loading the operating system.

In one exemplary embodiment, the operation of the editing the reference storage segment as the target storage segment that is not allowed to be allocated to the boot loader for storing the system file includes: adjusting a storage location of data stored in the storage space, so that a storage segment, which does not store the data and a capacity of which is smaller than a file size of the system file and is larger than a file size of the target system file, does not exist in the storage space, wherein the boot loader is configured to apply to the storage space for a storage segment for storing the system file according to the file size of the target system file.

In one exemplary embodiment, the operation of the adjusting a storage location of data stored in the storage space includes: extracting target data from a storage segment, a capacity of which is smaller than the file size of the target system file and which stores data, in the storage space; and using the target data to partition the reference storage segment into a plurality of storage segments as the target storage segment, wherein a capacity of each of the plurality of storage segments is smaller than the file size of the target system file.

In one exemplary embodiment, after the editing the reference storage segment as a target storage segment that is not allowed to be allocated to the boot loader for storage of the system file, the method further includes: starting the boot loader; and applying to the storage space for a storage segment, a capacity of which is larger than the file size of the system file and which meets a target capacity redundancy condition, through the boot loader.

In one exemplary embodiment, the operation of the applying to the storage space for a storage segment, a capacity of which is larger than the file size of the system file, through the boot loader for storing the system file includes: obtaining the system file from a remote server through the boot loader, wherein the remote server is configured to provide the system file for the boot loader; detecting the file size of the system file through the boot loader; applying to the storage space for a storage segment, the capacity of which is larger than the file size of the system file, through the boot loader; and storing the system file in the storage segment, which is allocated by the storage space in response to the applying for the storage segment through the boot loader through the boot loader.

In one exemplary embodiment, the operation of the detecting a reference storage segment in the storage space includes: selecting, from the storage segments partitioned from the storage space, candidate storage segments that are allowed to be allocated to the boot loader for storing the system file; and selecting, from the candidate storage segments, the reference storage segment, the capacity of which is smaller than the file size of the system file.

In one exemplary embodiment, the operation of the selecting, from the storage segments partitioned from the storage space, candidate storage segments that are allowed to be allocated to the boot loader for storage of the system file includes: detecting a first spatial attribute of each of the storage segments partitioned from the storage space, wherein the first spatial attribute is configured to indicate usage of each of the storage segments partitioned from the storage space; and determining storage segments, the first spatial attribute of each of which is available, as the candidate storage segments.

In one exemplary embodiment, the operation of the selecting, from the candidate storage segments, the reference storage segment, the capacity of which is smaller than the file size of the system file includes: selecting, as alternative storage segments, storage segments, the capacity of which is smaller than the file size of the system file, from the candidate storage segments; and selecting, as the reference storage segment, a storage segment, the capacity of which is larger than the file size of the target system file in the system file, from the alternative storage segments, wherein the boot loader is configured to apply to the storage space for a storage segment for storing the system file according to the file size of the target system file.

In one exemplary embodiment, before the detecting the reference storage segment in the memory space, the method further includes: querying the file size of the system file from the remote server, where the remote server is configured to provide the system file for the boot loader, and the boot loader is configured to obtain the system file from the remote server and store the system file to the allocated storage segment in the storage space during startup.

In one exemplary embodiment, the operation of the querying the file size of the system file from a remote server includes one of the following: sending a first query request to the remote server, wherein the first query request is configured to request the file size of the system file; or sending a second query request to the remote server, wherein the second query request is configured to request the file size of the system file and the file size of the target system file, and the boot loader is configured to apply to the storage space for the storage segment for storing the system file according to the file size of the target system file.

According to a second aspect, a apparatus of starting a server is provided. An initialization module, a boot loader, and a storage space are deployed on a server. The initialization module is configured to initialize server hardware of the server in a case where the server is started, and the boot loader is configured to store a system file in the storage space and use the system file to load an operating system for the server. The apparatus is applied to the initialization module, and includes a detection module and an editing module.

The detection module is configured to, in a case where the server is start and before the server runs the boot loader, detect a reference storage segment in the storage space, wherein the reference storage segment is a storage segment, a storage capacity of which is smaller than a file size of a system file, in the storage space.

The editing module is configured to edit the reference storage segment as a target storage segment that is not allowed to be allocated to the boot loader for storing the system file, wherein after the reference storage segment is edited as the target storage segment, the boot loader is allowed to be run.

According to a third aspect, a system of starting a server is provided, which includes an initialization module and a boot loader, wherein a storage space is further deployed on a server, the initialization module is configured to initialize server hardware of the server in a case where the server is started, and the boot loader is configured to store a system file in the storage space and use the system file to load an operating system for the server. The initialization module is configured to perform the steps of the initialization module in any of the above method embodiments in a case where running. The boot loader is configured to perform the steps of the boot loader in any of the above method embodiments in a case where running.

According to a fourth aspect, a non-volatile readable storage medium is further provided, in which a computer program is stored. The computer program is configured to perform the steps in any one of the above method embodiments in a case where running.

According to a fifth aspect, an electronic device is further provided, which includes a memory and a processor. A computer program is stored in the memory, and the processor is configured to run the computer program to perform the steps in any one of the above method embodiments.

Through the present disclosure, in a case where the server is started but the boot loader has not yet been run, the initialization module is used to detect the storage segment, a storage capacity of which is smaller than a file size of the system file, in the storage space, and the storage segment, the storage capacity of which is smaller than the file size of the system file, is edited as the target storage segment that is not allowed to be allocated to the boot loader for storing the system file, so that in a case where the boot loader needs to store the system file, only the storage segment, the storage capacity of which is larger than or equal to the file size of the system file, may be used. Moreover, since the initialization module for initializing the server hardware of the server is deployed on the server, an “overlap” conflict in file storage in the boot loader may be solved during initialization of the server hardware of the server, and then the boot loader may be run, thereby solving the problem of low server startup efficiency and achieving the effect of improving the server startup efficiency.

### BRIEF DESCRIPTION OF THE DRAWINGS

FIG. 1 is a block diagram of a hardware structure of a server device of a method of starting a server according to an embodiment of the present disclosure.

FIG. 2 is a schematic diagram of a method of starting a server according to an embodiment of the present disclosure.

FIG. 3 is a schematic diagram of a method for adjusting a storage location of data stored in a storage space according to an embodiment of the present disclosure.

FIG. 4 is a flowchart of a working process of an initialization module according to an embodiment of the present disclosure.

FIG. 5 is a flowchart of a working process of a boot loader according to an embodiment of the present disclosure.

FIG. 6 is a timing diagram of a working process of a Basic Input Output System (BIOS) and a Preboot Execute Environment (PXE) according to an embodiment of the present disclosure.

FIG. 7 is a structural block diagram of an apparatus of starting a server according to an embodiment of the present disclosure.

FIG. 8 is a schematic diagram of a system of starting a server according to an embodiment of the present disclosure.

FIG. 9 is a structural block diagram of an electronic device according to an embodiment of the present disclosure.

### DETAILED DESCRIPTION OF THE EMBODIMENTS

Embodiments of the present disclosure are described below with reference to the drawings and in conjunction with the embodiments in detail.

It is to be noted that the terms “first”, “second” and the like in the specification, claims and the above drawings of the present disclosure are used for distinguishing similar objects rather than describing a specific sequence or a precedence order.

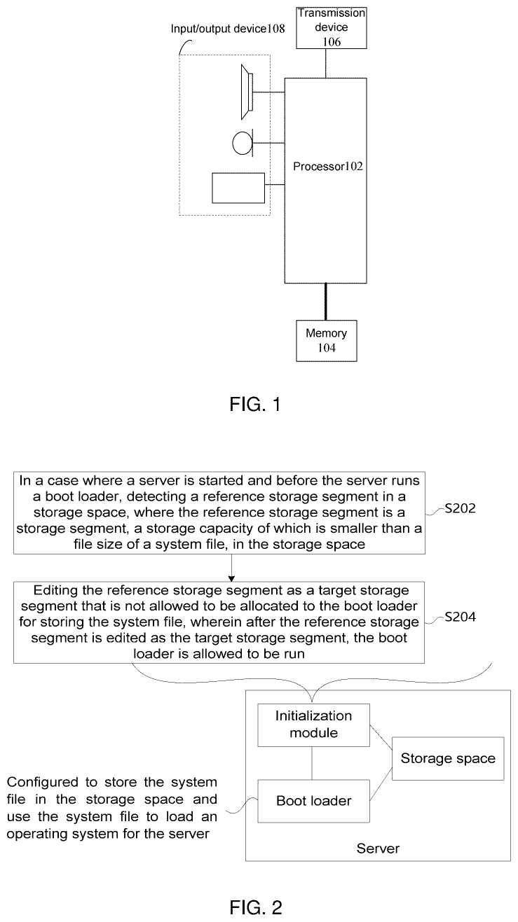

The method embodiment provided by the embodiments of the present disclosure may be performed in a server device or a similar computing apparatus. Taking running on a server device as an example, FIG. 1 is a block diagram of a hardware structure of a server device of a method of starting a server according to an embodiment of the present disclosure. As shown in FIG. 1, the server device may include one or more (only one is shown in FIG. 1) processors 102 (the processors 102 may include, but are not limited to, processing apparatuses such as a Micro Controller Unit (MCU) or a Field Programmable Gate Array (FPGA)) and a memory 104 for storing data. The above server device may further include a transmission device 106 and an input/output device 108 for communication functions. Those of ordinary skill in the art may understand that the structure shown in FIG. 1 is only schematic and not intended to limit the structure of the above server device. For example, the server device may further include more or fewer components than those shown in FIG. 1, or have a different configuration from that shown in FIG. 1.

The memory 104 may be configured to store a computer program, for example, a software program or a module of application software, such as a computer program corresponding to a method of starting a server in the embodiments of the present disclosure. The processor 102 runs the computer program stored in the memory 104 to perform various functional applications and data processing, that is, to implement the above method. The memory 104 may include a high speed Random Access Memory (RAM) and may further include a non-volatile memory such as one or more magnetic storage apparatuses, a flash, or other non-volatile solid state memories. In some examples, the memory 104 may include memories remotely located relative to the processor 102, which may be connected to the server device over a network. Examples of the above network include, but are not limited to, the Internet, the Intranet, a local area network, a mobile communication network, and a combination thereof.

The transmission module 106 is configured to receive or transmit data through a network. The above optional examples of the network may include a wireless network provided by a communication provider of the server device. In one example, the transmission device 106 includes a Network Interface Controller (NIC) that may be connected to other network devices through a base station to communicate with the Internet. In one example, the transmission device 106 may be a Radio Frequency (RF) module, which is configured to communicate with the Internet in a wireless manner.

In the present embodiment, a method of starting a server is provided. FIG. 2 is a schematic diagram of a method of starting a server according to an embodiment of the present disclosure. As shown in FIG. 2, an initialization module, a boot loader, and a storage space are deployed on a server. The initialization module is configured to initialize server hardware of the server in a case where the server is started, and the boot loader is configured to store a system file in the storage space and use the system file to load an operating system for the server. The method is applied to the initialization module. The method of starting a server includes the following steps.

At S202, in a case where the server is started and before the server runs the boot loader, detecting a reference storage segment in the storage space, wherein the reference storage segment is a storage segment, a storage capacity of which is smaller than a file size of a system file, in the storage space.

At S204, editing the reference storage segment as a target storage segment that is not allowed to be allocated to the boot loader for storing the system file, wherein after the reference storage segment is edited as the target storage segment, the boot loader is allowed to be run.

Through the above steps, in a case where the server is started but the boot loader has not yet been run, the initialization module is used to detect the storage segment, a storage capacity of which is smaller than a file size of the system file, in the storage space, and the storage segment, the storage capacity of which is smaller than the file size of the system file, is edited as the target storage segment that is not allowed to be allocated to the boot loader for storing the system file, so that in a case where the boot loader needs to store the system file, only the storage segment, the storage capacity of which is larger than or equal to the file size of the system file, may be used. Moreover, since the initialization module for initializing the server hardware of the server is deployed on the server, an “overlap” conflict in file storage in the boot loader may be solved during initialization of the server hardware of the server, and then the boot loader may be run, thereby solving the problem of low server startup efficiency and achieving the effect of improving the server startup efficiency.

Optionally, in the present embodiment, a software or hardware module having a function of initializing the server hardware may, but is not limited to, be used as the above initialization module, such as a BIOS, a Unified Extensible Firmware Interface (UEFI), a server remote management controller, etc.

Optionally, in the present embodiment, the server may, but is not limited to, run the boot loader during startup, and load the operating system through the boot loader. The boot loader may include, but is not limited to, EtherBoot (an open source BIOS-based network boot program), NetBoot (network boot), a PXE, iPXE (an extended version of PXE), etc.

Optionally, in the present embodiment, the boot loader may, but is not limited to, obtain one or more system files from a remote or external device, and use the system file to load the operating system for the server. For the system file obtained by the boot loader, the boot loader may, but is not limited to, store one or more system files in the storage space of the server according to the usage. The above system file may include, but is not limited to, an initrd (initial root file system) file, a vmlinuz (Linux kernel) file, a PXE background configuration, a PXE configuration file, a network driver file, etc.

That is, taking a scenario where the boot loader obtains the initrd file, the vmlinuz file, the PXE background configuration, the PXE configuration file, and the network driver file as an example, the boot loader may select the initrd file, the vmlinuz file, and the PXE background configuration to be stored in the storage space of the server according to the usage of the system file, or may store all the obtained system files in the storage space of the server.

Optionally, in the present embodiment, during server startup, the server may, but is not limited to, load the operating system from a local storage device. The above local storage device may include, but is not limited to, a hard disk, a solid-state hard disk, an optical disk, etc. In a case where the server does not discover a loadable operating system, the boot loader is used to load the operating system. Alternatively, the server may directly use the boot loader to load the operating system and the like during startup.

In the technical solution provided in the above S202, the storage segment, the storage capacity of which is smaller than the file size of the system file, in the storage space may, but is not limited to, be detected first without waking up the boot loader in a case where the server is started up.

Optionally, in the present embodiment, the initialization module may, but is not limited to, read the file size of one or more pre-stored system files to be stored in the storage space. The above pre-storage manner may include, but is not limited to, recording in the storage space, burning in the hard disk, etc. Alternatively, the initialization module may also obtain the file size of one or more system files to be stored in the storage space by interacting with the boot loader.

Optionally, in the present embodiment, the reference storage segment, the storage capacity of which is smaller than the file size of the system file, is determined from the storage space according to the file size of the system file. For example, in a case where the system file includes a system file A having a file size A and a system file B having a file size B, a reference storage segment, the storage capacity of which is smaller than the file size (A+B) of the system file may are determined from the storage space.

In one exemplary embodiment, the reference storage segment in the storage space may, but is not limited to, be detected in the following manner: selecting, from the storage segments partitioned from the storage space, candidate storage segments that are allowed to be allocated to the boot loader for storing the system file; and selecting, from the candidate storage segments, the reference storage segment, the capacity of which is smaller than the file size of the system file.

Optionally, in the present embodiment, data may, but is not limited to, be stored in the storage space in storage segments. Each storage segment may include, but is not limited to, a plurality of attributes, such as a storage location, an access permission, a storage type, whether it is in an available state or not, etc. The storage segments, the attributes of which match those of the system file for storing the system file may, but is not limited to, be selected as the candidate storage segment that is allowed to be allocated to the boot loader for storing the system file from the storage segments partitioned from the storage space.

Optionally, in the present embodiment, each storage segment partitioned from the storage space has a corresponding storage capacity. The initialization module selects, from the candidate storage segments, the storage segment, the capacity of which is smaller than the file size of the system file, as the reference storage segment according to the file size of the system file.

In one exemplary embodiment, the candidate storage segments that are allowed to be allocated to the boot loader for storing the system file may, but is not limited to, be selected from the storage segments partitioned from the storage space in the following manner: detecting a first spatial attribute of the storage segments partitioned from the storage space, wherein the first spatial attribute is configured to indicate usage of the storage segments partitioned from the storage space; and determining storage segments, the first spatial attribute of which is available, as the candidate storage segments.

Optionally, in the present embodiment, the first spatial attribute of each storage segment may, but is not limited to, be detected. In a case where the first spatial attribute indicates that the current storage segment is in an available state, the corresponding storage segment is determined as the candidate storage segment. Alternatively, in a case where the first spatial attribute indicates that the current storage segment is in an unavailable state such as failed, occupied, etc., the current storage segment is ignored.

In one exemplary embodiment, the reference storage segment, the capacity of which is smaller than the file size of the system file may, but is not limited to, be selected from the candidate storage segments in the following manner: selecting, as alternative storage segments, the storage segments, the capacity of which is smaller than the file size of the system file, from the candidate storage segments; and selecting, as the reference storage segment, a storage segment, the capacity of which is larger than the file size of the target system file in the system file, from the alternative storage segments, wherein the boot loader is configured to apply to the storage space for the storage segment for storing the system file according to the file size of the target system file.

Optionally, in the present embodiment, the above target system file may, but is not limited to, be one or more of the system files such as an initrd file, a vmlinuz file, a PXE background configuration, a PXE configuration file, a network driver file, etc.

Optionally, in the present embodiment, the boot loader may, but is not limited to, use the storage segment applied to the storage space according to the file size of the target system file to store the system file. The system file may include, but is not limited to, a plurality of system files including the target system file.

Optionally, in the present embodiment, the storage segments, the capacity of which is smaller than the file size of the system file, are selected as the alternative storage segments from the candidate storage segments, and then the storage segment, the capacity of which is larger than the file size of the target system file in the system file, is selected as the reference storage segment from the alternative storage segments, so as to obtain the reference storage segment, the storage capacity of which may be configured for storage of the target system file but cannot meet the complete system file.

In one exemplary embodiment, before detecting the reference storage segment in the memory space, the boot loader may, but is not limited to, operate in the following manner: querying the file size of the system file from a remote server, wherein the remote server is configured to provide the system file for the boot loader, and the boot loader is configured to obtain the system file from the remote server and store the system file to the allocated storage segment in the storage space during startup.

Optionally, in the present embodiment, the boot loader may, but is not limited to, obtain the system file from the remote server and store the system file in the storage space during the server startup.

Optionally, in the present embodiment, the remote server may, but is not limited to, be configured to store the system file required by the boot loader and file information of the system file. The above file information may include, but is not limited to, a file size, a file type, and the like of the system file.

In one exemplary embodiment, the file size of the system file may, but is not limited to, be queried from the remote server in the following manner: sending a first query request to the remote server, wherein the first query request is configured to request the file size of the system file; or sending a second query request to the remote server, wherein the second query request is configured to request the file size of the system file and the file size of the target system file, and the boot loader is configured to apply to the storage space for the storage segment for storing the system file according to the file size of the target system file.

Optionally, in the present embodiment, the first query request may, but is not limited to, be sent to the remote server, and information of the file size of the system file returned by the remote server in response to the first query request may be received. Alternatively, the second query request is sent to the remote server, and information of the file sizes of the system file and the target system file returned by the remote server in response to the second query request is received.

In the technical solution provided in the above S204, the target storage segment may, but is not limited to, be obtained by modifying the attributes of the reference storage segment to not allow the reference storage segment to be allocated to the boot loader for storing the system file to obtain the target storage segment, for example, modifying the storage location, the access permission, the storage type, and the like of the reference storage segment.

In one exemplary embodiment, the reference storage segment may, but is not limited to, be edited as the target storage segment that is not allowed to be allocated to the boot loader for storing the system file in, the following manner: querying a second spatial attribute of the reference storage segment, wherein the second spatial attribute is configured to indicate usage of the reference storage segment; and configuring the second spatial attribute as unavailable to obtain the target storage segment, wherein a storage segment, the spatial attribute of which is configured as unavailable, is not allowed to be allocated to the boot loader for storage of the system file.

Optionally, in the present embodiment, the second spatial attribute is configured to indicate the usage of the reference storage segment, which may include, but is not limited to, available, unavailable, etc.

Optionally, in the present embodiment, the second spatial attribute may, but is not limited to, be obtained by detecting the usage of the reference storage segment, and modifying the second spatial attribute of the reference storage segment as unavailable to obtain the target storage segment, the second spatial attribute of which is unavailable, so that the target storage segment is not allowed to be allocated to the boot loader for storing the system file.

Optionally, in the present embodiment, by configuring the second spatial attribute of the reference storage segment as unavailable, in a case where the boot loader applies to the server for the storage space according to the file size of the target system file during configuration of the operating system, the storage segment, the capacity of which is smaller than the file size of the system file, and the storage segment, the capacity of which is larger than the file size of the target system file in the system file, are not allocated to the boot loader because the second spatial attribute is unavailable, so that the boot loader may apply for the storage space having sufficient storage capacity without modifying the boot loader.

In one exemplary embodiment, the reference storage segment may, but is not limited to, be edited as the target storage segment that is not allowed to be allocated to the boot loader for storage of the system file in the following manner: querying a space type of the reference storage segment, wherein the space type is configured to indicate a service type of a storage service provided by a storage segment; and configuring the space type as a target type to obtain the target storage segment, wherein the boot loader is only allowed to use a storage segment, the space type of which is a reference type.

Optionally, in the present embodiment, the space type of the storage segment is configured to indicate the service type of the storage service provided by the storage segment, which may include, but is not limited to, a driver health protocol, a configuration protocol, a cryptographic protocol, a runtime service type, a boot service type, etc.

Optionally, in the present embodiment, the space type of the reference storage segment may, but is not limited to, be configured as a space type different from the space type that is allowed to be used by the boot loader, for example, taking a scenario where the boot loader is only allowed to use the storage segment, of which the space type is the boot service type, as an example, the space type of the reference storage segment is configured as the driver health protocol, the configuration protocol, the cryptographic protocol, the runtime service type, or the like different from the space type that is allowed to be used by the boot loader.

In one exemplary embodiment, the space type may, but is not limited to, be configured as the target type to obtain the target storage segment in the following manner: configuring the space type as the runtime service type to obtain the target storage segment, wherein the target type is the runtime service type, a storage segment, the space type of which is configured as the runtime service type, is not configured to provide the storage service for a stage of loading the operating system, the reference type includes the boot service type, and a storage segment, the space type of which is configured as the boot service type, is configured to provide the storage service for the stage of loading the operating system.

Optionally, in the present embodiment, during loading of the operating system, the boot loader may, but is not limited to, use the storage segment of the boot service type to store the system file. Therefore, the space type of the reference storage segment is configured as the runtime service type different from the boot service type, so that the target storage segment of the runtime service type cannot provide the storage service for the boot loader during loading of the operating system.

Optionally, in the present embodiment, by configuring the space type of the reference storage segment as the space type that the boot loader cannot apply for use, in a case where the boot loader applies to the server for the storage space, the storage segment, the capacity of which is smaller than the file size of the system file, and the storage segment, the capacity of which is larger than the file size of the target system file in the system file, are not allocated to the boot loader due to the mismatched space types, and the boot loader may apply for the storage space having sufficient storage capacity without modifying the boot loader.

In one exemplary embodiment, the reference storage segment may, but is not limited to, be edited as the target storage segment that is not allowed to be allocated to the boot loader for storing the system file in the following manner: adjusting a storage location of data stored in the storage space, so that a storage segment, which does not store the data and a capacity of which is smaller than a file size of the system file and is larger than a file size of the target system file, does not exist in the storage space, wherein the boot loader is configured to apply to the storage space for the storage segment for storing the system file according to the file size of the target system file.

Optionally, in the present embodiment, the data may, but is not limited to, be written to the storage segment, the capacity of which is smaller than the file size of the system file, and the storage segment, the capacity of which is larger than the file size of the target system file in the system file, so that the storage segment, which does not store the data and a capacity of which is smaller than the file size of the system file and is larger than the file size of the target system file, does not exist in the storage space. The above written data may include, but is not limited to, the data of the storage segment, which stores the data, pre-stored data for performing a write operation, etc.

Optionally, in the present embodiment, the storage segment, which stores the data, may, but is not limited to, be adjusted. For example, the data in the storage segment, which stores the data, is transferred to the storage segment, which does not store the data, so that the storage segment, which does not store the data and a capacity of which is smaller than the file size of the system file and is larger than the file size of the target system file, does not exist in the storage space. Alternatively, the data in the storage segment, which stores the data, is copied to the storage segment, which does not store the data, so that the storage segment, which does not store the data and a capacity of which is smaller than file size of the system file and is larger than the file size of the target system file, does not exist in the storage space, etc.

In one exemplary embodiment, the storage location of the data stored in the storage space may, but is not limited to, be adjusted in the following manner: extracting target data from a storage segment, a capacity of which is smaller than the file size of the target system file and which stores the data, in the storage space; and using the target data to partition the reference storage segment into a plurality of storage segments, wherein each of the storage segments serves the target storage segment, wherein the capacity of each of the plurality of storage segments is smaller than the file size of the target system file.

Optionally, in the present embodiment, a part of data in the storage segment, the capacity of which is smaller than the file size of the target system file and which stores the data, may, but is not limited to, be extracted as the target data. Alternatively, all data in the storage segment, the capacity of which is smaller than the file size of the target system file and which stores the data, may be extracted as the target data, etc.

Optionally, in the present embodiment, a difference between the storage capacity of the reference storage segment and the file size of the target system file may, but is not limited to, be determined. The target storage segment may be obtained by writing the target data, a data amount of which is larger than or equal to the above difference, into the reference storage segment, so that the capacity of the target storage segment is smaller than the file size of the target system file.

Optionally, in the present embodiment, by writing the target data into the reference storage segment and partitioning the reference storage segment into the plurality of storage segments, wherein each of the storage segments serves as the target storage segment, in a case where the boot loader applies to the server for the storage space, there is no storage segment, the capacity of which is smaller than the file size of the system file, and the storage segment, the capacity of which is larger than the file size of the target system file in the system file, in the storage space, and the boot loader may only apply for the storage segment, the capacity of which is larger than the file size of the target system file, so that the boot loader may apply for the storage space having sufficient storage capacity without modifying the boot loader.

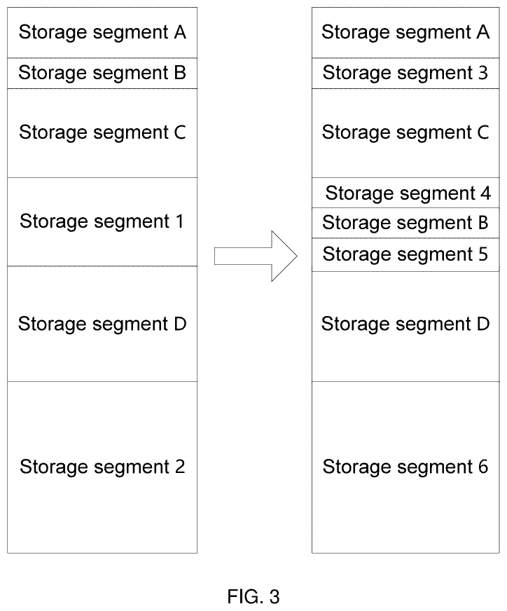

In one exemplary embodiment, an example of a method for adjusting a storage location of data stored in a storage space is provided. FIG. 3 is a schematic diagram of a method for adjusting a storage location of data stored in a storage space according to an embodiment of the present disclosure. As shown in FIG. 3, taking a scenario where the storage space includes a storage segment A, a storage segment B, a storage segment C, and a storage segment D, which store data, and a storage segment 1 and a storage segment 2, which do not store the data, where a reference storage segment includes the storage segment 1, and the storage capacity of the storage segment 2 is larger than the file size of a system file as an example, the data in the storage segment B may, but is not limited to, be migrated to the storage segment 1, so that the storage segment 1 is partitioned into the storage segment 4 and the storage segment 5, the capacity of which is smaller than the file size of a target system file, and the storage space does not include the storage segment, the capacity of which is smaller than the file size of the system file and is larger than the file size of the target system file.

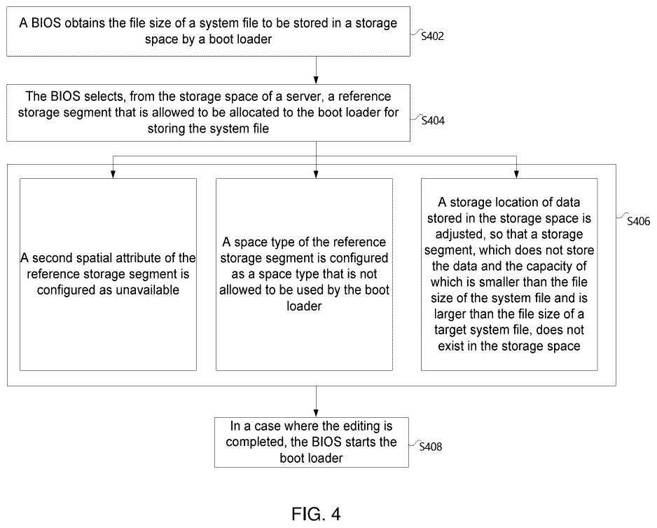

In one exemplary embodiment, an example of a working process of an initialization module is provided. FIG. 4 is a flowchart of a working process of an initialization module according to an embodiment of the present disclosure. As shown in FIG. 4, taking the initialization module as a BIOS as an example, the BIOS may, but is not limited to, operate in the following manner.

At S402, a BIOS obtains the file size of a system file to be stored in a storage space by a boot loader, and the boot loader applies to the storage space of a server for a storage segment according to the file size of a target system file, wherein the file size of the system file is larger than or equal to that of a target system file.

At S404, the BIOS selects, from the storage space of the server, a reference storage segment that is allowed to be allocated to the boot loader for storing the system file, wherein the reference storage segment is a storage segment, the storage capacity of which is larger than the file size of the target system file and is smaller than the file size of the system file.

At S406, the reference storage segment is edited as a target storage segment that is not allowed to be allocated to the boot loader for storage of the system file in one or a combination of the following manners.

Manner 1: a second spatial attribute of the reference storage segment is configured as unavailable.

Manner 2: a space type of the reference storage segment is configured as a space type that is not allowed to be used by the boot loader.

Manner 3: a storage location of data stored in the storage space is adjusted, so that a storage segment, which does not store the data and the capacity of which is smaller than the file size of the system file and is larger than the file size of the target system file, does not exist in the storage space.

At S408, in a case where the editing is completed, the BIOS starts the boot loader.

In one exemplary embodiment, after the reference storage segment is edited as the target storage segment that is not allowed to be allocated to the boot loader for storing the system file, the boot loader may, but is not limited to, operate in the following manner: starting up the boot loader; and applying to the storage space for the storage segment, the capacity of which is larger than the file size of the system file, through the boot loader.

Optionally, in the present embodiment, after editing the reference storage segment as the target storage segment that is not allowed to be allocated to the boot loader for storing the system file, the initialization module may, but is not limited to, start the boot loader. During configuration of an operating system for the server, the boot loader may, but is not limited to, apply for the storage segment having a corresponding capacity according to the file size of the target system file. Since the storage segment, the capacity of which is smaller than the file size of the system file and is larger than the file size of the target system file, in the storage space cannot be allocated to the boot loader through configuration, the boot loader may only obtain the storage segment, the capacity of which is larger than the file size of the system file, for storing the system file.

In one exemplary embodiment, the boot loader may, but is not limited to, apply to the storage space for the storage segment, the capacity of which is larger than the file size of the system file, for storing the system file in the following manner: obtaining the system file from a remote server through the boot loader, wherein the remote server is configured to provide the system file for the boot loader; detecting the file size of the system file through the boot loader; applying to the storage space for the storage segment, the capacity of which is larger than the file size of the system file and which meets a target capacity redundancy condition, through the boot loader; and storing the system file in the storage segment allocated by the storage space in response to an application of the boot loader through the boot loader.

Optionally, in the present embodiment, in the process of obtaining the system file including the target system file from the remote server, the boot loader may, but is not limited to, obtain the file size of the system file including the target system file, and apply to the storage space for the storage segment according to the target system file. Since the storage segment, the capacity of which is smaller than the file size of the system file and is larger than the file size of the target system file, in the storage space cannot be allocated to the boot loader through configuration, the boot loader may only obtain the storage segment, the capacity is larger than the file size of the system file, for storing the system file.

Optionally, in the present embodiment, the boot loader may, but is not limited to, preferentially apply for the storage segment having a larger storage capacity according to the storage capacity of the storage segment. For example, taking the maximum storage capacity of 500 and the actual storage capacity required by the boot loader of 100 as an example, the boot loader first applies for the storage segment of 500, and then applies for the storage segment having the storage capacity of 250 until the storage segment is obtained, or in a case where the storage capacity applied is smaller than the file size of the target system file, the application fails. The storage capacity of the storage segment obtained in this way is larger, exceeding the actual needs, ensuring that the system file may be fully stored.

Optionally, in the present embodiment, the storage space consumed by the format such as an alignment operation may, but is not limited to, be offset by increasing the above target capacity redundancy condition. If the number of files or data to be loaded increases, the sum of the file sizes of the system files and the storage capacity of the target capacity redundancy condition may, but is not limited to, be calculated as the size of the storage space applied by the boot loader according to the actual situation, so as to avoid file and data memory usage conflicts in a case where the boot loader uses the applied storage space.

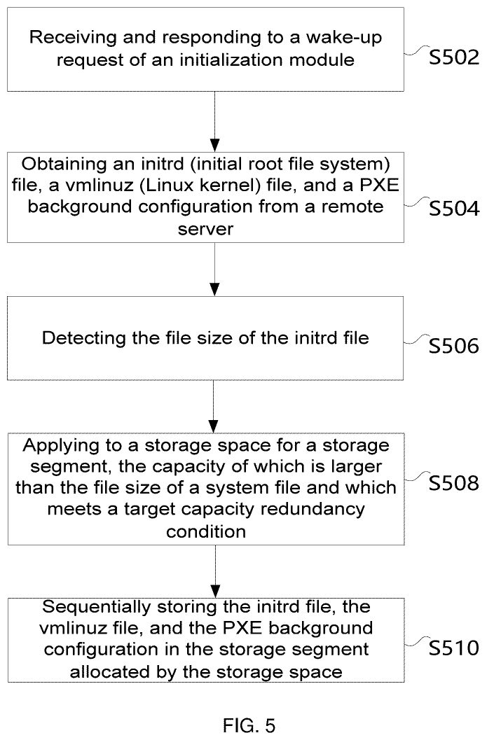

In one exemplary embodiment, an example of a working process of a boot loader is provided. FIG. 5 is a flowchart of a working process of a boot loader according to an embodiment of the present disclosure. As shown in FIG. 5, taking the boot loader as a PXE, with a system file including an initrd file, a vmlinuz file, and a PXE background configuration, and a target system file being the initrd file as an example, the PXE may, but is not limited to, operate in the following manner.

At S502, receiving and responding to a wake-up request of an initialization module.

At S504, obtaining an initrd (initial root file system) file, a vmlinuz (Linux kernel) file, and a PXE background configuration from a remote server.

At S506, detecting the file size of the initrd file.

At S508, applying to a storage space for a storage segment, the capacity of which is larger than the file size of a system file and which meets a target capacity redundancy condition.

At S510, sequentially storing the initrd file, the vmlinuz file, and the PXE background configuration in the storage segment allocated by the storage space, wherein the storage capacity of the storage segment allocated by the storage space is larger than the sum of the file sizes of the initrd file, the vmlinuz file, and the PXE background configuration.

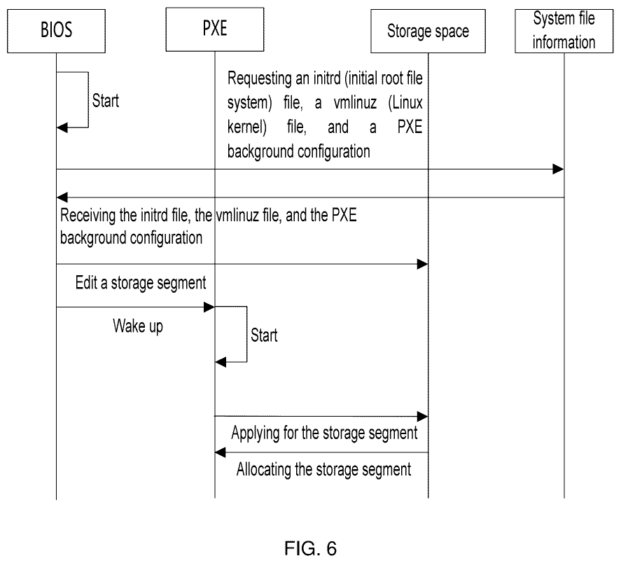

In one exemplary embodiment, an example of a working process of a BIOS and a PXE is provided. FIG. 6 is a timing diagram of a working process of a BIOS and a PXE according to an embodiment of the present disclosure. As shown in FIG. 6, taking an initialization module as the BIOS and a boot loader as the PXE, with a system file including an initrd file, a vmlinuz file, and a PXE background configuration, and a target system file being the initrd file as an example, the BIOS and the PXE may, but is not limited to, operate in the following manner.

The BIOS is started, file information of the initrd file, the vmlinuz file, and the PXE background configuration are requested, and the file information of the initrd file, the vmlinuz file, and the PXE background configuration is received to obtain the file size of a system file. The BIOS edits a storage space of a server according to the file size of the system file to obtain a target storage segment. The BIOS wakes up the PXE.

The PXE is started in response to the wake-up of the BIOS, applies to the storage space for a storage segment according to the file size of the initrd file, and uses the storage segment allocated by the storage space for storage of the initrd file, the vmlinuz file, and the PXE background configuration.

The storage space receives the request of the PXE, sequentially detects, from the largest storage capacity to the smallest, whether the storage space may be allocated to the PXE, and allocates a storage space, the storage capacity of which is larger than the sum of the file sizes of the initrd file, the vmlinuz file, and the PXE background configuration to the PXE.

Through the above description of implementations, those skilled in the art may clearly know that the method according to the above embodiments may be implemented by means of software plus a necessary common hardware platform, certainly by means of hardware; but in many cases, the former is the better implementation. Based on such understanding, the technical solution of the present disclosure, which is essential or contributes to the related art, may be embodied in the form of a software product. The computer software product is stored in a non-volatile readable storage medium (such as a Read-Only Memory (ROM)/RAM, a magnetic disk and an optical disc), including a number of instructions for causing a terminal device (which may be a mobile phone, a computer, a server, or a network device, etc.) to perform the methods described in various embodiments of the present disclosure.

The embodiments further provide an apparatus of starting a server, which is configured to implement the above embodiments and optional implementations. The embodiments and optional implementations that have been elaborated will not be repeated here. The term “module” used below can realize a combination of software and/or hardware with an intended function. Although the apparatus described in the following embodiment is preferably realized by software, but by hardware or a combination of software and hardware is also possible and conceived.

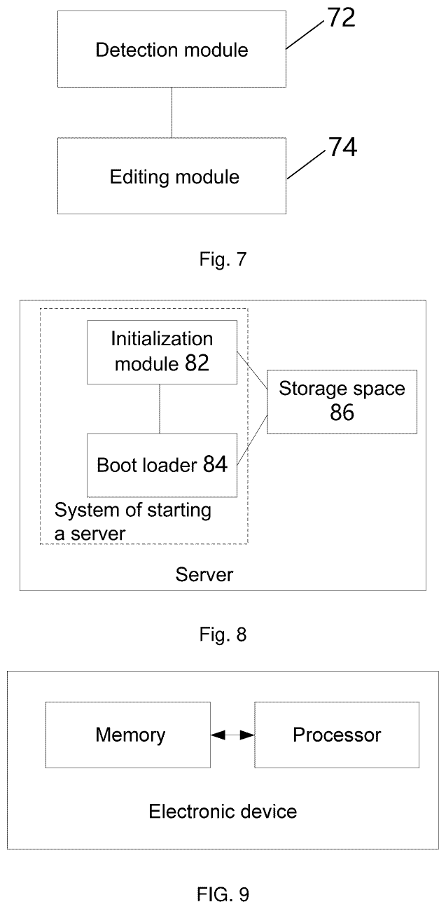

FIG. 7 is a structural block diagram of an apparatus of starting a server according to an embodiment of the present disclosure. As shown in FIG. 7, an initialization module, a boot loader, and a storage space are deployed on a server. The initialization module is configured to initialize server hardware of the server in a case where the server is started, and the boot loader is configured to store a system file in the storage space and use the system file to load an operating system for the server. The apparatus is applied to the initialization module. The apparatus includes a detection module 72 and an editing module 74.

The detection module 72 is configured to, in a case where the server is started and before the server runs the boot loader, detect a reference storage segment in the storage space, wherein the reference storage segment is a storage segment, a storage capacity of which is smaller than a file size of a system file, in the storage space.

The editing module 74 is configured to edit the reference storage segment as a target storage segment that is not allowed to be allocated to the boot loader for storing the system file, wherein after the reference storage segment is edited as the target storage segment, the boot loader is allowed to be run.

Through the above apparatus, in a case where the server is started but the boot loader has not yet been run, the initialization module is used to detect the storage segment, a storage capacity of which is smaller than the file size of the system file, in the storage space, and the storage segment, the storage capacity of which is smaller than the file size of the system file, is edited as the target storage segment that is not allowed to be allocated to the boot loader for storing the system file, so that in a case where the boot loader needs to store the system file, only the storage segment, the storage capacity of which is larger than or equal to the file size of the system file, may be used. Moreover, since the initialization module for initializing the server hardware of the server is deployed on the server, an “overlap” conflict in file storage in the boot loader may be solved during initialization of the server hardware of the server, and then the boot loader may be run, thereby solving the problem of low server startup efficiency and achieving the effect of improving the server startup efficiency.

In one exemplary embodiment, the editing module includes a first query unit and a first configuration unit.

The first query unit is configured to query a second spatial attribute of the reference storage segment, wherein the second spatial attribute is configured to indicate usage of the reference storage segment.

The first configuration unit is configured to configure the second spatial attribute as unavailable to obtain the target storage segment, wherein a storage segment, a spatial attribute of which is configured as unavailable, is not allowed to be allocated to the boot loader for storing the system file.

In one exemplary embodiment, the editing module includes a second query unit and a second configuration unit.

The second query unit is configured to query a space type of the reference storage segment, wherein the space type is configured to indicate a service type of a storage service provided by a storage segment.

The second configuration unit is configured to configure the space type as a target type to obtain the target storage segment, wherein the boot loader is only allowed to use a storage segment, a space type of which is a reference type.

In one exemplary embodiment, the second configuration unit is further configured to: configure the space type as a runtime service type to obtain the target storage segment, wherein the target type is the runtime service type, a storage segment, a space type of which is configured as the runtime service type, is not configured to provide the storage service for a stage of loading the operating system, the reference type includes a boot service type, and a storage segment, a space type of which is configured as the boot service type, is configured to provide a storage service for the stage of loading the operating system.

In one exemplary embodiment, the editing module includes an adjustment unit.

The adjustment unit is configured to adjust a storage location of data stored in the storage space, so that a storage segment, which does not store the data and a capacity of which is smaller than a file size of the system file and is larger than a file size of a target system file, does not exist in the storage space, wherein the boot loader is configured to apply to the storage space for a storage segment for storing the system file according to the file size of the target system file.

In one exemplary embodiment, the adjustment unit is further configured to: extract target data from a storage segment, a capacity of which is smaller than the file size of the target system file and which stores the data, in the storage space; and use the target data to partition the reference storage segment into a plurality of storage segments, wherein each of the storage segments serves as the target storage segment, wherein a capacity of each of the plurality of storage segments is smaller than the file size of the target system file.

In one exemplary embodiment, the apparatus further includes a startup module and an application module.

The startup module is configured to start the boot loader.

The application module is configured to apply to the storage space for a storage segment, a capacity of which is larger than the file size of the system file, through the boot loader for storing the system file.

In one exemplary embodiment, the application module includes an acquisition unit, a detection unit, an application unit, and a storage unit.

The detection unit is configured to obtain the system file from a remote server through the boot loader, wherein the remote server is configured to provide the system file for the boot loader.

The detection unit is configured to detect the file size of the system file through the boot loader.

The application unit is configured to apply to the storage space for a storage segment, the capacity of which is larger than the file size of the system file and the capacity of which meets a target capacity redundancy condition, through the boot loader.

The storage unit is configured to store the system file in the storage segment, which is allocated by the storage space in response to the applying for the storage segment through the boot loader, through the boot loader.

In one exemplary embodiment, the detection module includes a first selection unit and a second selection unit.

The first selection unit is configured to select, from the storage segments partitioned from the storage space, candidate storage segments that are allowed to be allocated to the boot loader for storing the system file.

The second selection unit is configured to select, from the candidate storage segments, the reference storage segment, the capacity of which is smaller than the file size of the system file.

In one exemplary embodiment, the first selection unit is further configured to: detect a first spatial attribute of each of the storage segments partitioned from the storage space, wherein the first spatial attribute is configured to indicate usage of each of the storage segments partitioned from the storage space; and determine storage segments, the first spatial attribute of each of which is available, as the candidate storage segments.

In one exemplary embodiment, the first selection unit is further configured to: select, as alternative storage segments, storage segments, the capacity of which is smaller than the file size of the system file, from the candidate storage segments; and select, as the reference storage segment, a storage segment, the capacity of which is larger than the file size of a target system file in the system file, from the alternative storage segments, wherein the boot loader is configured to apply to the storage space for the storage segment for storing the system file according to the file size of the target system file.

In one exemplary embodiment, the apparatus further includes a query module.

The module is configured to query the file size of the system file from a remote server, wherein the remote server is configured to provide the system file for the boot loader, and the boot loader is configured to obtain the system file from the remote server and store the system file to the allocated storage segment in the storage space during startup.

In one exemplary embodiment, the query module includes one of the following: a first sending unit and a second sending unit.

The first sending unit is configured to send a first query request to the remote server, wherein the first query request is configured to request the file size of the system file.

The second sending unit is configured to send a second query request to the remote server, wherein the second query request is configured to request the file size of the system file and the file size of a target system file, and the boot loader is configured to apply to the storage space for the storage segment for storing the system file according to the file size of the target system file.

It is to be noted that, each of the above modules may be realized by software or hardware. For the latter, the each of the above modules may, but is not limited to, be realized in the following manners: all of the above modules are in the same processor; or, the above modules are respectively in different processors in form of any combination.

The embodiments of the present disclosure further provide a system of starting a server. FIG. 8 is a schematic diagram of a system of starting a server according to an embodiment of the present disclosure. As shown in FIG. 8, the server startup system includes an initialization module 82 and a boot loader 84, wherein a storage space 86 is further deployed on a server, the initialization module 82 is configured to initialize server hardware of the server in a case where the server is started up, and the boot loader 84 is configured to store a system file in the storage space 86 and use the system file to load an operating system for the server. The initialization module 82 is configured to perform the steps of the initialization module in any of the above method embodiments in a case where running. The boot loader 84 is configured to perform the steps of the boot loader in any of the above method embodiments in a case where running.

Through the above system of starting a server, in a case where the server is started but the boot loader has not yet been run, the initialization module is used to detect the storage segment, the storage capacity of which is smaller than the file size of the system file, in the storage space, and the storage segment, the storage capacity of which is smaller than the file size of the system file, is edited as the target storage segment that is not allowed to be allocated to the boot loader for storing the system file, so that in a case where the boot loader needs to store the system file, only the storage segment, the storage capacity of which is larger than or equal to the file size of the system file, may be used. Moreover, since the initialization module for initializing the server hardware of the server is deployed on the server, an “overlap” conflict in file storage in the boot loader may be solved during initialization of the server hardware of the server, and then the boot loader may be run, thereby solving the problem of low server startup efficiency and achieving the effect of improving the server startup efficiency.

The optional examples in the present embodiment may refer to the above embodiments and the examples described in the optional implementations, which will not be elaborated herein.

The embodiments of the present disclosure further provide a non-volatile readable storage medium, in which a computer program is stored. The computer program is configured to perform the steps in any one of the above method embodiments in a case where running.

In one exemplary embodiment, the above non-volatile readable storage medium may include, but is not limited to, a U disk, an ROM, an RAM, a mobile hard disk, a magnetic disk, a compact disc, and other media capable of storing the computer program.

The embodiments of the present disclosure further provide an electronic device. FIG. 9 is a structural block diagram of an electronic device according to an embodiment of the present disclosure. As shown in FIG. 9, the above electronic device includes a memory and a processor. A computer program is stored in the memory, and the processor is configured to run the computer program to perform the steps in any of the above method embodiments.

In one exemplary embodiment, the above electronic device may further include a transmission device and an input/output device. The transmission device is connected with the above processor, and the input/output device is connected to the above processor.

The optional examples in the present embodiment may refer to the above embodiments and the examples described in the exemplary implementations, which will not be elaborated herein.

It is apparent that those skilled in the art should appreciate that the above modules and steps of the present disclosure may be implemented by a general-purpose computing apparatus, and they may be centralized in a single computing apparatus or distributed on a network composed of multiple computing apparatuses; they may be implemented by a program code which is capable of being executed by the computing apparatus, so that they may be stored in a storage apparatus and executed by the computing apparatus; and in some situations, the presented or described steps may be executed in an order different from that described here; or they are made into integrated circuit modules, respectively; or multiple modules and steps of them are made into a single integrated circuit module to realize. In this way, the present disclosure is not limited to any particular combination of hardware and software.

The above are only the optional embodiments of the present disclosure, and are not intended to limit the present disclosure, and for those of ordinary skill in the art, various modifications and changes may be made to the present disclosure. Any modifications, equivalent substitutions, improvements, etc. within the principle of the present disclosure shall be included in the scope of protection of the present disclosure.

1. A method of starting a server, wherein an initialization module, a boot loader, and a storage space are deployed on a server, the initialization module is configured to initialize server hardware of the server in a case where the server is started, and the boot loader is configured to store a system file in the storage space and use the system file to load an operating system for the server; the method is applied to the initialization module, and comprises:
in a case where the server is started and before the server runs the boot loader, detecting a reference storage segment in the storage space, wherein the reference storage segment is a storage segment, a storage capacity of which is smaller than a file size of the system file, in the storage space; and
editing the reference storage segment as a target storage segment that is not allowed to be allocated to the boot loader for storing the system file, wherein after the reference storage segment is edited as the target storage segment, the boot loader is allowed to be run.

2. The method according to claim 1, wherein the editing the reference storage segment as a target storage segment that is not allowed to be allocated to the boot loader for storing the system file comprises:
querying a second spatial attribute of the reference storage segment, wherein the second spatial attribute is configured to indicate usage of the reference storage segment; and
configuring the second spatial attribute as unavailable to obtain the target storage segment, wherein a storage segment, a spatial attribute of which is configured as unavailable, is not allowed to be allocated to the boot loader for storing the system file.

3. The method according to claim 1, wherein the editing the reference storage segment as a target storage segment that is not allowed to be allocated to the boot loader for storing the system file comprises:
querying a space type of the reference storage segment, wherein the space type is configured to indicate a service type of a storage service provided by the reference storage segment; and
configuring the space type as a target type to obtain the target storage segment, wherein the boot loader is only allowed to use a storage segment, a space type of which is a reference type.

4. The method according to claim 3, wherein the configuring the space type as a target type to obtain the target storage segment comprises:
configuring the space type as a runtime service type to obtain the target storage segment, wherein the target type is the runtime service type, a storage segment, a space type of which is configured as the runtime service type, is not configured to provide a storage service for a stage of loading the operating system, the reference type comprises a boot service type, and a storage segment, a space type of which is configured as the boot service type, is configured to provide a storage service for the stage of loading the operating system.

5. The method according to claim 1, wherein the editing the reference storage segment as a target storage segment that is not allowed to be allocated to the boot loader for storing the system file comprises:
adjusting a storage location of data stored in the storage space, so that a storage segment, which does not store data and a capacity of which is smaller than a file size of the system file and is larger than a file size of a target system file, does not exist in the storage space, wherein the boot loader is configured to apply to the storage space for a storage segment for storing the system file according to the file size of the target system file.

6. The method according to claim 5, wherein the adjusting a storage location of data stored in the storage space, so that a storage segment, which does not store data and a capacity of which is smaller than a file size of the system file and is larger than a file size of a target system file, does not exist in the storage space comprises:
transferring data in a storage segment, which stores data, in the storage space to a storage segment, which does not store data, so that the storage segment, which does not store data and a capacity of which is smaller than the file size of the system file and is larger than the file size of the target system file, does not exist in the storage space.

7. The method according to claim 5, wherein the adjusting a storage location of data stored in the storage space, so that a storage segment, which does not store data and a capacity of which is smaller than a file size of the system file and is larger than a file size of a target system file, does not exist in the storage space comprises:
copying data in a storage segment, which stores data, in the storage space to a storage segment, which does not store data, so that the storage segment, which does not store data and a capacity of which is smaller than the file size of the system file and is larger than the file size of the target system file, does not exist in the storage space.

8. The method according to claim 5, wherein the adjusting a storage location of data stored in the storage space comprises:
extracting target data from a storage segment, a capacity of which is smaller than the file size of the target system file and which stores data, in the storage space; and
using the target data to partition the reference storage segment into a plurality of storage segments, wherein each of the storage segments serves as the target storage segment, wherein a capacity of each of the plurality of storage segments is smaller than the file size of the target system file.

9. The method according to claim 8, wherein the extracting target data from a storage segment, a capacity of which is smaller than the file size of the target system file and which stores the data, in the storage space comprises:
determining a difference between the capacity of the reference storage segment and the file size of the target system file; and
extracting, as the target data, data of which an amount conforms to the difference from the storage segment, the capacity of which is smaller than the file size of the target system file and which stores data, in the storage space.

10. The method according to claim 1, wherein after the editing the reference storage segment as a target storage segment that is not allowed to be allocated to the boot loader for storing the system file, the method further comprises:
starting the boot loader; and
applying to the storage space for a storage segment, a capacity of which is larger than the file size of the system file, through the boot loader for storing the system file.

11. The method according to claim 10, wherein the applying to the storage space for a storage segment, a capacity of which is larger than the file size of the system file, through the boot loader for storing the system file comprises:
obtaining the system file from a remote server through the boot loader, wherein the remote server is configured to provide the system file for the boot loader;
detecting the file size of the system file through the boot loader;
applying to the storage space for a storage segment, the capacity of which is larger than the file size of the system file and the capacity of which meets a target capacity redundancy condition, through the boot loader; and
storing the system file in the storage segment, which is allocated by the storage space in response to the applying for the storage segment through the boot loader, through the boot loader.

12. The method according to claim 1, wherein the detecting a reference storage segment in the storage space comprises:
selecting, from storage segments partitioned from the storage space, candidate storage segments that are allowed to be allocated to the boot loader for storing the system file; and
selecting, from the candidate storage segments, the reference storage segment, the capacity of which is smaller than the file size of the system file.

13. The method according to claim 12, wherein the selecting, from storage segments partitioned from the storage space, candidate storage segments that are allowed to be allocated to the boot loader for storing the system file comprises:
detecting a first spatial attribute of each of the storage segments partitioned from the storage space, wherein the first spatial attribute is configured to indicate usage of each of the storage segments partitioned from the storage space; and
determining storage segments, the first spatial attribute of each of which is available, as the candidate storage segments.

14. The method according to claim 13, wherein the selecting, from the candidate storage segments, the reference storage segment, the capacity of which is smaller than the file size of the system file comprises:
selecting, as alternative storage segments, storage segments, the capacity of which is smaller than the file size of the system file, from the candidate storage segments; and
selecting, as the reference storage segment, a storage segment, the capacity of which is larger than the file size of a target system file in the system file, from the alternative storage segments, wherein the boot loader is configured to apply to the storage space for a storage segment for storing the system file according to the file size of the target system file.

15. The method according to claim 1, wherein before the detecting the reference storage segment in the memory space, the method further comprises:
querying the file size of the system file from a remote server, wherein the remote server is configured to provide the system file for the boot loader, and the boot loader is configured to obtain the system file from the remote server and store the system file to the allocated storage segment in the storage space during startup.

16. The method according to claim 15, wherein the querying the file size of the system file from a remote server comprises one of the following:
sending a first query request to the remote server, wherein the first query request is configured to request the file size of the system file; or
sending a second query request to the remote server, wherein the second query request is configured to request the file size of the system file and the file size of a target system file, and the boot loader is configured to apply to the storage space for a storage segment for storing the system file according to the file size of the target system file.

17. (canceled)

18. A system of starting a server, comprising:
an initialization module and a boot loader, wherein a storage space is further deployed on the server, the initialization module is configured to initialize server hardware of the server in a case where the server is started, and the boot loader is configured to store a system file in the storage space and use the system file to load an operating system for the server;
the initialization module and the boot loader of; and
the boot loader is the boot loader according to.

19. A non-volatile readable storage medium, wherein a computer program is stored in the non-volatile readable storage medium, the computer program is configured to be executed by a processor to implement the steps of the method according to claim 1.

20. An electronic device, comprising a memory, a processor, and a computer program stored in the memory and executable on the processor, wherein the processor is configured to implement the steps of the method according to claim 1 when executing the computer program.

21. A non-volatile readable storage medium, wherein a computer program is stored in the non-volatile readable storage medium, the computer program is configured to be executed by a processor to implement the steps of the method according to claim 2.
